(19) United States
(12) Patent Application Publication
(10) Pub. No.: US 2020/0394707 A1
(43) Pub. Date: Dec. 17, 2020

(54) METHOD AND SYSTEM FOR IDENTIFYING ONLINE MONEY-LAUNDERING CUSTOMER GROUPS

(71) Applicant: Alibaba Group Holding Limited, George Town, KY (US)

(72) Inventor: Ya Guo, Hangzhou (CN)

(73) Assignee: Alibaba Group Holding Limited, George Town, KY (US)

(21) Appl. No.: 16/985,071

(22) Filed: Aug. 4, 2020

Related U.S. Application Data
(63) Continuation of application No. PCT/CN2018/119323, filed on Dec. 5, 2018.

(30) Foreign Application Priority Data
Feb. 28, 2018 (CN) 201810164789.2

(51) Int. Cl. G06Q 40/02; G06N 20/00; G06K 9/62

(52) U.S. Cl. CPC G06Q 40/02; G06K 9/6257; G06K 9/6223; G06N 20/00

(57) ABSTRACT

One embodiment provides a method and system for detecting online money laundering. During operation, the system can obtain, from an online financial platform, online financial transaction records associated with a plurality of customer accounts and establish fund-transfer relationships among the plurality of customer accounts based on the transaction records. The system can further perform a cluster-analysis operation to group the plurality of customer accounts into a number of clusters based on the established fund-transfer relationships and apply a machine-learning model to determine whether a respective customer-account cluster is involved in online money laundering.

### RELATED APPLICATION

Under 35 U.S.C. § 120 and § 365(c), this application is a continuation of PCT Application No. PCT/CN2018/119323, entitled “METHOD AND APPARATUS FOR IDENTIFYING SUSPICIOUS MONEY-LAUNDERING GANGS,” by inventor Ya Guo, filed 5 Dec. 2018, which claims priority to Chinese Patent Application No. 201810164789.2, filed on 28 Feb. 2018.

### BACKGROUND

### Field

The present application relates to a method and system for facilitating online financial transactions. More specifically, this application relates to a method and system that can identify money-laundering activities among online financial transactions.

### Related Art

The rapid development of computing technologies has allowed the Internet technology to be extended into the financial domain. The various types of financial services provided over the Internet (e.g., third-party payment, peer-to-peer lending, crowdfunding, online banking, online money market fund distribution, Internet insurance, and Internet brokerage, etc.) can be referred to as “Internet finance.” Internet finance can expand channels of the financial services, optimize the provisioning of funds, lower the cost of transactions, simplify transaction procedures, address defects of traditional finance, and accommodate the diversified demands of users.

However, the various features of the Internet (e.g., anonymity, responsiveness, convenience, etc.) can also provide favorable conditions for illegal activity, such as online money laundering. In recent years, money laundering has migrated from traditional payment tools (e.g., traditional bank transactions) to payment tools provided by Internet finance. It has become increasingly common for criminals to launder money using online payment tools. Hence, to advance the development of the Internet finance industry, the problem of how to quickly and effectively detect and prevent online money laundering needs to be solved urgently.

### SUMMARY

One embodiment provides a method and system for detecting online money laundering. During operation, the system can obtain, from an online financial platform, online financial transaction records associated with a plurality of customer accounts and establish fund-transfer relationships among the plurality of customer accounts based on the transaction records. The system can further perform a cluster-analysis operation to group the plurality of customer accounts into a number of clusters based on the established fund-transfer relationships and apply a machine-learning model to determine whether a respective customer-account cluster is involved in online money laundering.

In a variation on this embodiment, the system can train the machine-learning model using labeled data associated with a set of sample customer-account clusters.

In a further variation, the machine-learning model can include a binary-classification model, and training the binary-classification model can include labeling a first number of sample customer-account clusters as blacklisted and a second number of sample customer-account clusters as whitelisted.

In a further variation, labeling a respective sample customer-account cluster as blacklisted can include determining that a number of customer accounts within the respective sample customer-account cluster are known money-laundering customer accounts and, in response to a ratio of the known money-laundering customer accounts within the respective sample customer-account cluster exceeding a predetermined threshold, labeling the respective sample customer-account cluster as blacklisted.

In a variation on this embodiment, the system can extract a feature vector from the respective customer-account cluster and use the feature vector as an input to the machine-learning model.

In a variation on this embodiment, establishing the fund-transfer relationships among the plurality of customer accounts can include constructing a fund-transfer graph based on the transaction records. A respective node in the fund-transfer graph corresponds to a customer account, and an edge in the fund-transfer graph corresponds to a fund-transfer relationship between two customer accounts.

In a further variation, the system can construct a subgraph for each cluster and extract a feature vector from the subgraph using a technique based on detection of network motifs within the subgraph.

In a variation on this embodiment, establishing the fund-transfer relationships can include determining whether a fund-transfer relationship exists between two customer accounts based on a total amount of funds transferred between the two customer accounts.

In a further variation, establishing the fund-transfer relationships comprises determining a direction of the fund-transfer relationship between the two customer accounts, and the determined direction includes one of: a first direction, a second opposite direction, and a bi-direction.

In a variation on this embodiment, performing the cluster-analysis operation can include implementing a label propagation algorithm (LPA) or a k-means clustering algorithm.

### BRIEF DESCRIPTION OF THE FIGURES

FIG. 1 presents a diagram illustrating an exemplary computing environment, according to one embodiment.

FIG. 2 presents a flowchart illustrating an exemplary process for detecting suspicious customer groups, according to one embodiment.

FIG. 3 illustrates an exemplary money-laundering-detection system, according to one embodiment.

FIG. 4 presents a diagram illustrating the exemplary architecture of a server, according to one embodiment.

FIG. 5 illustrates an exemplary computer system, according to one embodiment.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide a solution to the technical problems of detecting online money laundering. More specifically, the system constructs a fund-transfer graph, with the nodes in the graph being the user account and the edges being the transaction relationship. The system can use a cluster-analysis technique to cluster the nodes in the fund-transfer graph into a number of groups and create a subgraph for each group of nodes. The system can then extract feature vectors (e.g., by finding network motifs) from the subgraphs and apply a previously trained machine-learning model (e.g., a binary classification model) to identify a particular type of subgraphs, thus facilitating the detection of groups of customer accounts suspicious of participating in money-laundering activates. In addition to known suspicious behaviors, the system can also discover, using an anomaly-detection technique, unknown risky or suspicious behaviors by detecting anomalous subgraphs.

### Anomalous-Customer-Group-Detection System

Many online financial services (e.g., online payment systems) rely upon knowledge and experiences of domain experts to detect anomalous transactions. For example, it is known that groups organizing online gambling activities are more likely to be involved in illegal financial activities, such as money laundering. Domain experts can model the behaviors of gamblers based on their own experiences and data collected about the gamblers. Such models can then be used to infer money-laundering risks of customers.

However, this approach can only model the behavior of individual customers and is heavily reliant on the knowledge and experiences of the domain experts, thus limiting its application in detecting malicious groups of customers or new, unknown types of risky customer behavior. To improve effectiveness and efficiency in detecting online money laundering, the disclosed embodiments construct fund-transfer graphs and analyze such graphs using machine-learning technologies in order to identify malicious activity among a large number of customers and transactions among the customers.

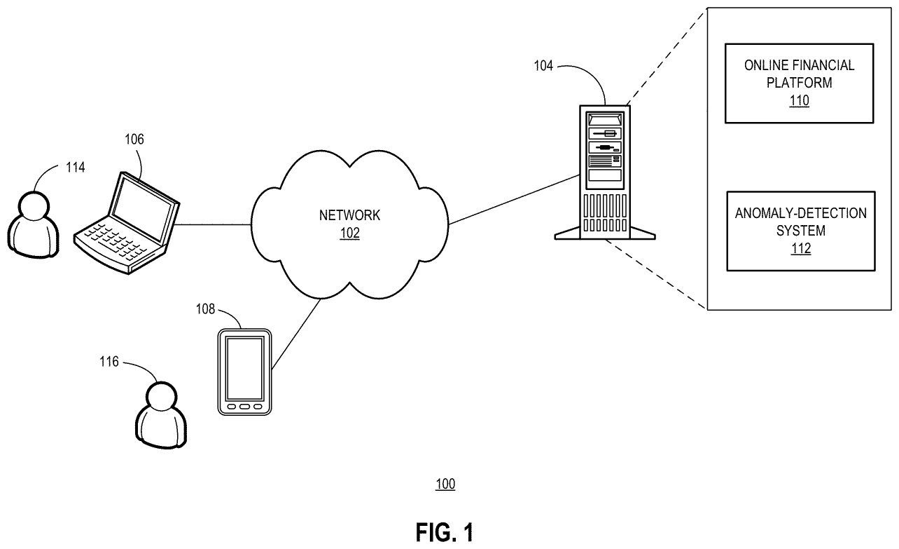

FIG. 1 presents a diagram illustrating an exemplary computing environment, according to one embodiment. In FIG. 1, computing environment 100 includes a network 102, a server 104, and a number of computing devices, including computing devices 106 and 108.

Network 102 can include various types of wired or wireless networks. In some embodiments, network 102 can include the public switched telephone network (PSTN) and the Internet. Server 104 can be a physical server that includes a standalone computer, a virtual server provided by a cluster of standalone computers, or a cloud server. Server 104 can be coupled to an online financial platform 110 (e.g., a peer-to-peer payment platform) and an anomaly-detection system 112.

Computing devices 106 and 108 can include various mobile devices, including but not limited to: smartphones, tablet computers, laptop computers, personal digital assistants (PDAs), various wearable computing devices (e.g., smartglasses and smartwatches), etc. In addition to mobile devices, the solutions provided herein can also be applied to other types of computing devices, such as desktop computers or computer servers. A user can access the financial services provided by online financial platform 110 via a corresponding computing device and network 102. For example, user 114 can access a peer-to-peer payment service provided by financial platform 110 via his laptop computer 106. More specifically, user 114 can send payment to user 116, who can access the peer-to-peer payment service via his smartphone 108.

There can be many users accessing online financial platform 110 and many transactions among the users. A typical money-laundering operation can involve multiple user accounts among which illegal funds can be transferred. In the disclosed embodiments, anomaly-detection system 112 can access data associated with online transactions, including transaction partners and the amount of funds involved in each transaction, and can use machine-learning techniques to mine the transaction relationship among the customers in order to identify suspicious customer groups who are likely to participate in online money laundering.

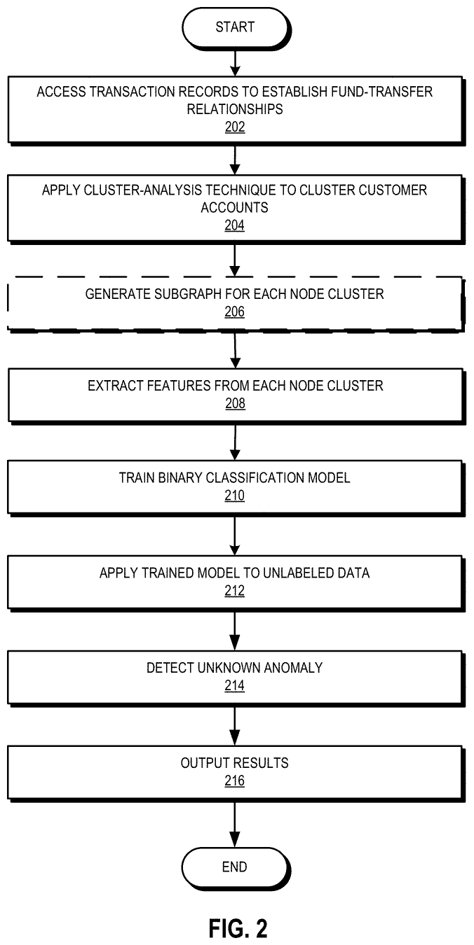

FIG. 2 presents a flowchart illustrating an exemplary process for detecting suspicious customer groups, according to one embodiment. During operation, the system can access transaction records of an online financial platform to establish fund-transfer relationships among customer accounts (operation 202). The transaction records can include recordings of fund transfers among various types of customer accounts (also referred to as fund accounts), such as an account registered in a payment platform (typically identifiable by a phone number or email address), a debit card (typically identifiable by a debit card number), a credit card (typically identifiable by a credit card number), a passbook issued by a bank, or the like. A financial institution (e.g., banks or providers of the Internet finance) usually maintain a record of each transaction occurring on its platform or associated with its accounts. Each transaction record can include a fund-in account indicating the account into which the fund is transferred, a fund-out account indicating the account from which the fund is transferred, a transaction amount indicating the amount of funds being transferred between the fund-in and fund-out accounts, the transaction time, etc.

Due to the dynamic nature (e.g., fund transfers can occur non-stop on the online platform) and the volume of transaction records associated with the online financial platform, in some embodiments, while detecting money laundering activities, the system can filter the transaction records according to a number of predetermined rules to eliminate non-important transaction records (e.g., transaction records that are out of date or are associated with a small amount of funds) from consideration. The rules can be determined based on the characteristics of the financial service provided by the online financial platform in a practical application scenario, a money-laundering-detection accuracy requirement, a timeliness requirement, etc. For example, the system may detect money-laundering activities based on transaction records of certain services (e.g., fund transfers, deposits, withdrawals) within a predetermined time period (e.g., two months). In another example, the system may detect suspicious customer groups who may participate in money-laundering activities based on transaction records with the fund amount exceeding a predetermined threshold. In some embodiments, the rules can be established based on one or more of: the type of transaction, the transaction time, the transaction amount, and the transaction direction (e.g., whether the fund transferred in or out of an account). In other words, only transaction records that satisfy one or more statistical conditions (as defined by the aforementioned filtering rules) will be analyzed.

The system can establish fund-transfer relationships (e.g., in the form of a fund-transfer graph) among the customer accounts based on the transaction records. Similarly, while establishing the fund-transfer relationships, the system can apply a number of rules that are determined based on characteristics of the financial services provided by the online financial platform in a practical application scenario, a money-laundering-detection accuracy requirement, a timeliness requirement, etc. In a further embodiment, the rule used to establish the fund-transfer relationships may also be determined based on the algorithm used for the clustering of the customer accounts. Details about the clustering process will follow.

In one example, the system can establish a fund-transfer relationship between two customer accounts (e.g., a fund-in account and a fund-out account) involved in a transaction record satisfying the predetermined statistical conditions. This way, customer accounts that have funds transferred between themselves according to the transaction records are determined to have a fund-transfer relationship.

In one more example, a fund-transfer relationship between two customer accounts can be established if the total amount of fund transfer meets a predetermined threshold. More specifically, the system can select two customer accounts identified by a transaction record, and then accumulate, based on all transaction records satisfying the statistical conditions, the total fund-transfer amount between the two customer accounts. If the total fund-transfer amount is greater than a predetermined threshold, the system establishes a fund-transfer relationship between the accounts; otherwise, there is no fund-transfer relationship between these two accounts. This way, the system only considers customer accounts transferring relatively large sums between themselves, thus reducing the number of customer accounts needing consideration. Consequently, the speed and the accuracy of the cluster analysis can both be improved.

In yet another example, the fund-transfer direction (e.g., in or out of an account) may also need to be considered when establishing the fund-transfer relationship, because the fund-transfer direction may affect the result of certain cluster-analysis techniques. In such scenarios, the fund-transfer relationship between two customer accounts can be a unidirectional relationship or a bidirectional relationship. For example, the fund-transfer relationship between accounts A and B can be a unidirectional fund-transfer relationship from A to B, if funds are only transferred from account A to account B; a unidirectional fund-transfer relationship from B to A, if funds are only transferred from account B to account A; or a bidirectional fund-transfer relationship, if funds are transferred between accounts A and B in both directions. The established fund-transfer relationship can also include the amount of funds being transferred between the two accounts.

In one more example, while determining the direction of the fund-transfer relations, the system may also take into consideration the amount of funds transferred in each direction. For example, funds can be transferred between account A and account B in both directions. However, there can be an imbalance where a significantly larger sum is transferred in one direction than the other. In such a scenario, the system may ignore smaller sums, and mark the fund-transfer direction as the direction in which the larger sum is transferred. More specifically, when determining the fund-transfer relationship between two customer accounts, the system can accumulate, based on the transaction records, the total amount of funds transferred in each direction. If the difference between the sums transferred in the two directions reaches a certain criterion (i.e., if the imbalance is significantly large), the system can mark the fund-transfer direction as unidirectional in the direction in which the larger sum is transferred. Otherwise, the system can mark the fund-transfer direction as bidirectional, because the funds transferred in the two directions are more balanced. The imbalance criterion can be defined based on application requirements. For example, the imbalance criterion can be that the difference in fund-transfer amounts in the two directions reaches or exceeds a predetermined threshold. Alternatively, the imbalance criterion can be that the ratio between the fund transfer-amounts in the two directions reaches or exceeds a predetermined threshold.

In some embodiments, the system establishes the fund-transfer relationships among customer accounts by constructing a fund-transfer graph. The customer accounts identified by the transaction records can be the vertices or nodes in the fund-transfer graph and the fund-transfer relationship among the customer accounts determined based on the transaction records using the various aforementioned rules can be the edges in the graph. As discussed previously, the fund-transfer graph may be a non-directional graph, where fund-transfer directions are not taken into account; or a directional graph, where fund-transfer directions are taken into account. In a directional graph, some edges can be unidirectional and some edges can be bidirectional. Moreover, each edge can also be associated with one or more fund-transfer values.

Subsequent to establishing the fund-transfer relationships (e.g., by constructing the fund-transfer graph) among the customer accounts, the system can apply a cluster-analysis technique to divide the nodes (i.e., the customer accounts) in the fund-transfer graph into a number of clusters (operation 204). Various types of cluster-analysis techniques can be used, including supervised and non-supervised techniques. In some embodiments, the cluster-analysis technique used to divide the nodes into clusters can include one or more of: k-means clustering, density-based spatial clustering of applications with noise (DBSCAN), label-propagation algorithm (LPA), etc. Note that LPA is a semi-supervised machine-learning technique that assigns labels to previously unlabeled data points (in the current examples, customer accounts).

In some embodiments, each cluster of nodes (i.e., customer accounts) can be assigned an identifier (e.g., a group ID), and the system can optionally generate a subgraph for each node cluster based on the fund-transfer relationships among the nodes in the cluster (operation 206). Generating a subgraph for a node cluster can involve extracting all the nodes in the node cluster (e.g., all nodes sharing the same group ID) and all the edges connecting these nodes.

Subsequently, the system can extract features from each node cluster (operation 208). The system can use various feature-extraction techniques to extract features from each node cluster. In some embodiments, each node cluster can be represented by a subgraph and extracting features can involve a network-motif-analysis technique or a principle-component-analysis technique. For example, the network motifs in each subgraph can be detected using a network-motif-detection technique.

The system can train a binary-classification model using labeled data (operation 210). The labeled data can be the features extracted from the node clusters. More specifically, the system may label node clusters satisfying one or more predetermined whitelist conditions as whitelisted and label node clusters satisfying one or more predetermined blacklist conditions as blacklisted. For example, if a node cluster includes a node (i.e., a customer account) that is known to have participated in money-laundering activities, the node cluster is added to a black list and labeled as blacklisted. A customer account that is known to have participated in money-laundering activities can also be referred to as a malicious account. On the other hand, if a node cluster does not include any node (i.e., a customer account) that is known to have participated in money laundering, the node cluster is added to a white list and labeled as whitelisted. The customer accounts in a blacked-listed node cluster can be considered to belong to a money-laundering or malicious customer group, whereas the accounts in a whitelisted node cluster can be considered to belong to a normal customer group. The blacklist or whitelist condition can be determined based on the application requirements associated with particular service scenarios. In one embodiment, the blacklist condition can be set based on the number of malicious accounts in a node cluster or the ratio of the malicious accounts in the node cluster. For example, a blacklist condition can be met if the system determines that the number of known malicious accounts in a node cluster reaches or exceeds a threshold value or if the ratio of the known malicious accounts reaches or exceeds a threshold value. Alternatively, a blacklist condition can be met if the ratio of the known malicious accounts reaches or exceeds a predetermined first threshold value and a ratio of the normal accounts (e.g., accounts known to have not participated in money-laundering activities) in a node cluster is less than a predetermined second threshold value. Note that the whitelist condition can be set in a similar way.

Subsequent to the training, the system can apply the trained binary classification model (or the trained binary classifier) to the unlabeled data (operation 212). The input of the binary classification model can be features extracted from each node cluster, and the output of the binary classification model can be a determination on whether a particular node cluster belongs to the black list (i.e., it is associated with a money-laundering customer group) or the white list (i.e., it is associated with a normal customer group). In some embodiments, the output of the binary classification model can be a probability (e.g., the probability of the node cluster satisfying the blacklist condition). If such a probability exceeds a predetermined threshold (e.g., 0.6), the system can determine that customer accounts associated with the particular node cluster belong to a money-laundering customer group.

In some embodiments, in addition to using the trained binary classifier to detect money-laundering customer groups based on known risks (e.g., certain customers are known money launders), the system may also detect potential money-laundering customer groups based on unknown risks. More specifically, the system can apply an anomaly-detection technique to detect anomalous node clusters (operation 214). For example, the system may use the isolation forest technique, which can be based on an unsupervised learning algorithm, to detect anomalous node clusters. The system can then output the results of the binary classifier as well as the anomaly-detection results (operation 216). For example, the system can output one or more lists of groups of customers, indicating that these customer groups may be involved in money-laundering activities. The system may apply additional measures, such as additional monitoring of the detected accounts, sending reports to investigators, sending notifications to these customers, or suspending accounts. Such measures can decrease the likelihood of continued money-laundering activities on the online financial platform.

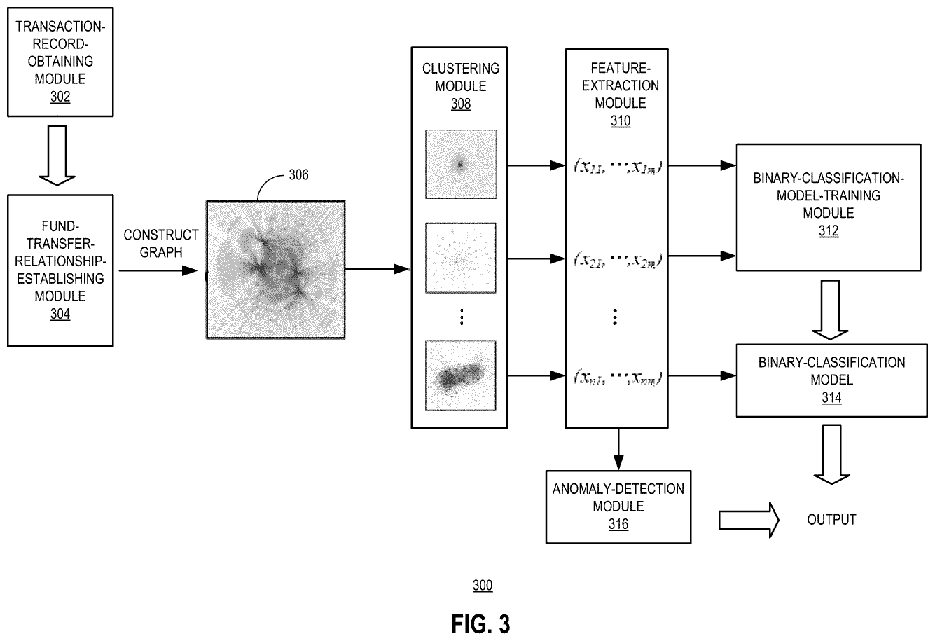

FIG. 3 illustrates an exemplary money-laundering-detection system, according to one embodiment. Money-laundering-detection system 300 can include a transaction-record-obtaining module 302 configured to obtain online financial records from one or more online financial platforms. Note that the ability to access transaction records across multiple platforms allows the system to detect potential money-laundering activities occurring across multiple platforms. In some examples, the online financial platform can be a third-party payment platform that allows the user to pay or accept payment from peers, pay credit card bills, pay utility bills, deposit checks, etc. Preventing malicious users from using such a platform (e.g., through fund transfer, deposit, or withdrawal) for money-laundering purposes can be an important security task. The transaction records maintained by the online financial platforms can provide essential data needed for detecting customer groups participating in money-laundering activities. Transaction-record-obtaining module 302 can obtain online transaction data directly from one or more online financial platforms, or it can obtain the online transaction from a financial data depository or a third-party organization (e.g., an auditing organization). The obtained transaction records can include dynamic data that tracks the current ongoing transactions or static data that includes records for a predetermined time period (e.g., the past few weeks, months, or years). In one example, transaction-record-obtaining module 302 can obtain, from a third-party payment platform, online transaction records for transactions within the past month.

Money-laundering-detection system 300 can include a fund-transfer-relationship-establishing module 304 configured to establish fund-transfer relationships among customer accounts based on transaction records, including transfers, deposits, withdrawals, etc. In one embodiment, fund-transfer-relationship-establishing module 304 can select a pair of accounts (e.g., account A and account B) that have been involved in a transaction according to the obtained transaction records, and can determine the total amount of fund transfer (including funds transferred from account A to account B and from account B to account A) between the two accounts over a predetermined period (e.g., one month). If the total amount of transferred funds is less than a predetermined threshold (e.g., $500), fund-transfer-relationship-establishing module 304 can determine that there is no fund-transfer relationship between accounts A and B. On the other hand, if the total amount of transferred funds reaches or exceeds the predetermined threshold, fund-transfer-relationship-establishing module 304 can determine that there is a fund-transfer relationship between accounts A and B. Fund-transfer-relationship-establishing module 304 can further determine a fund-transfer direction. If a ratio between the amount transferred from account A to account B is greater than a predetermined value (e.g., the ratio is greater than 5), the fund-transfer relationship can be unidirectional, from account A to account B; if a ratio between the amount transferred from account B to account A is greater than the predetermined value, the fund-transfer relationship can be unidirectional, from account B to account A. Otherwise, the fund-transfer relationship can be bidirectional.

Based on the established fund-transfer relationship, fund-transfer-relationship-establishing module 304 can construct a fund-transfer graph 306. The vertices or nodes in fund-transfer graph 306 can be the customer accounts, and the edges can be the fund-transfer relationships among the customer accounts. Fund-transfer graph 306 can be directional or non-directional. In one example, fund-transfer graph 306 is directional; some edges in fund-transfer graph 306 can be unidirectional; and some edges can be bidirectional.

Money-laundering-detection system 300 can include a clustering module 308 configured to perform clustering analysis on fund-transfer graph 306. In some embodiments, clustering module 308 can use one or more clustering techniques (e.g., LPA clustering) to group the nodes in fund-transfer graph 306 into a number of clusters and assign a group ID for nodes within the same cluster. Money-laundering-detection system 300 can further construct a subgraph for each node cluster. The nodes in each subgraph can be the nodes sharing the same group ID, and the edges in each subgraph can represent the fund-transfer relationships among nodes in the subgraphs.

Money-laundering-detection system 300 can include a feature-extraction module 310 configured to extract features from each subgraph. In one embodiment, feature-extraction module 310 can use a network-motif-based feature extraction technique to extract a feature vector from each subgraph.

Money-laundering-detection system 300 can include a binary-classification-model-training module 312 configured to train a binary-classification model 314 using labeled data. More specifically, money-laundering-detection system 300 can maintain a record of customer accounts known to have participated in money-laundering activities (referred to as money-laundering accounts) and customer accounts known to have not participated in money-laundering activities (referred to as normal accounts). Money-laundering-detection system 300 can then generate a set of training data using feature vectors extracted from the node clusters and its record of known customer accounts. For example, a node cluster having money-laundering accounts greater than a predetermined first ratio (e.g., 10%) and normal accounts less than a predetermined second ratio (e.g., 10%) can be labeled as a money-laundering node cluster; and a node cluster having money-laundering accounts less than the predetermined first ratio (e.g., 10%) and normal accounts greater than the predetermined second ratio (e.g., 10%) can be labeled as a normal node cluster. Other node clusters that do not meet either criterion can be labeled as unknown node clusters. Binary-classification-model-training module 312 can use labeled feature vectors from the money-laundering node clusters and normal node clusters to train a neural network (e.g., a binary classifier).

Money-laundering-detection system 300 can apply trained binary-classification model 314 to unlabeled data (e.g., unlabeled subgraphs or node clusters) to determine whether a node cluster is a money-laundering node cluster. An input to trained binary-classification model 314 can be the unlabeled feature vectors of a subgraph, and an output of trained binary-classification model 314 can be a probability value indicating the likelihood that the customer group corresponding to the subgraph participates in money-laundering activities. If the probability value is above a predetermined threshold (e.g., 60%), money-laundering-detection system 300 can generate additional outputs, such as reports to investigators, notifications to customers in the detected customer group, or signals to the payment platform to trigger additional monitoring or suspension of the customer accounts.

Money-laundering-detection system 300 can further include an anomaly-detection module 316 configured to detect node clusters with unknown risks. In addition to binary-classification model 314, feature vectors extracted from the node clusters can also be sent to anomaly-detection module 316, especially in the event of binary-classification model 314 failing to generate a classification output. Anomaly-detection module 316 can use a machine-learning based anomaly-detection technique (e.g., the isolation forest technique) to identify anomalous node clusters. The identified anomalous node cluster can further be provided to a security expert, which can perform further analysis on the customer accounts and transactions associated with these customer accounts to evaluate potential money-laundering risk. The evaluation results can further be sent to binary-classification-model-training module 312 for training of binary-classification model 314.

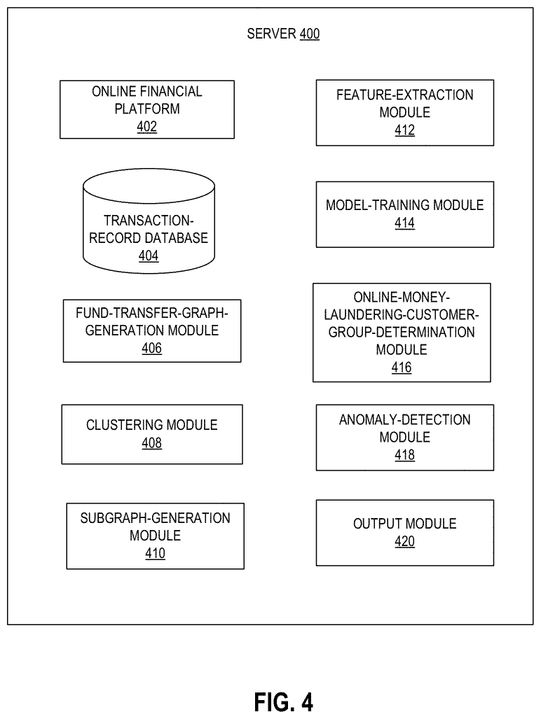

FIG. 4 presents a diagram illustrating the exemplary architecture of a server, according to one embodiment. In FIG. 4, server 400 can include an online financial platform 402, a transaction-record database 404, a fund-transfer-graph-generation module 406, a clustering module 408, a subgraph-generation module 410, a feature-extraction module 412, a model-training module 414, an online-money-laundering-customer-group-determination module 416, an anomaly-detection module 418, and an output module 420. Server 400 can be a physical server that includes a standalone computer, a virtual server provided by a cluster of standalone computers, or a cloud server implemented using cloud computing technologies.

Online financial platform 402 can provide various types of Internet finance services to customers, including, but not limited to: third-party payment, peer-to-peer lending, crowdfunding, online banking, online money market fund distribution, Internet insurance, and Internet brokerage, etc. Transaction-record database 404 stores records of transactions occurring on online financial platform 402. In the example shown in FIG. 4, financial platform 402 and transaction-record database 404 both reside on server 400. In an alternative embodiment, online financial platform 402 and/or transaction-record database 404 can reside on a different server and can be accessible by the various modules of server 400.

Fund-transfer-graph-generation module 406 can generate a fund-transfer graph based on the transaction records stored in transaction-record database 404. Only transaction records that meet certain statistical criteria (e.g., timeliness and transaction-amount requirements) will be considered when fund-transfer-graph-generation module 406 generates the fund-transfer graph. Moreover, the fund-transfer direction can be considered. In the fund-transfer graph, the nodes represent customer accounts, and the edges represent the amount and direction of the transferred funds. An edge connecting two nodes can be unidirectional or bidirectional depending on the fund-transfer direction between the corresponding customer accounts. For example, the amount of funds transferred in each direction can be accumulated separately over a predetermined time period. If the ratio between the fund-transfer amounts in the two directions is greater than a threshold, the fund-transfer relationship between the two nodes can be considered unidirectional, in the direction of the larger transfer amount. Otherwise, the fund-transfer relationship can be considered bidirectional.

Clustering module 408 can use various cluster-analysis techniques (e.g., k-means, LPA, DBSCAN, etc.) to divide the nodes in the fund-transfer graph into a number of clusters. Subgraph-generation module 410 can generate a subgraph for each cluster. Feature-extraction module 412 can extract a feature vector from each subgraph using a feature-extraction technique (e.g., a network-motif-based feature-extraction technique).

Model-training module 414 can use labeled data (e.g., feature vectors of blacklisted or whitelisted subgraphs) to train a machine-learning model (e.g., a binary classifier).

Online-money-laundering-customer-group-determination module 416 can determine, using the trained machine-learning model, whether a customer group corresponding to a subgraph is a money-laundering customer group, meaning that the likelihood of the customer group participating in money-laundering activities is high.

Anomaly-detection module 418 detects anomalous subgraphs from the plurality of subgraphs generated by subgraph-generation module 410 using one or more anomaly-detection techniques (e.g., the isolation forest technique). In some embodiments, subgraphs that cannot be classified by the binary classifier can be sent to anomaly-detection module 418 for anomaly detection.

Output module 420 can output the results of online-money-laundering-customer-group-determination module 416 and anomaly-detection module 418. For example, output module 420 can output a list of customer groups that are suspected of performing money laundering on the online financial platform. The list can be provided to investigators. In a different example, output module 420 can output one or more messages to online financial platform 402, instructing online financial platform 402 to perform additional monitoring on suspicious customer groups or to suspend certain customer accounts.

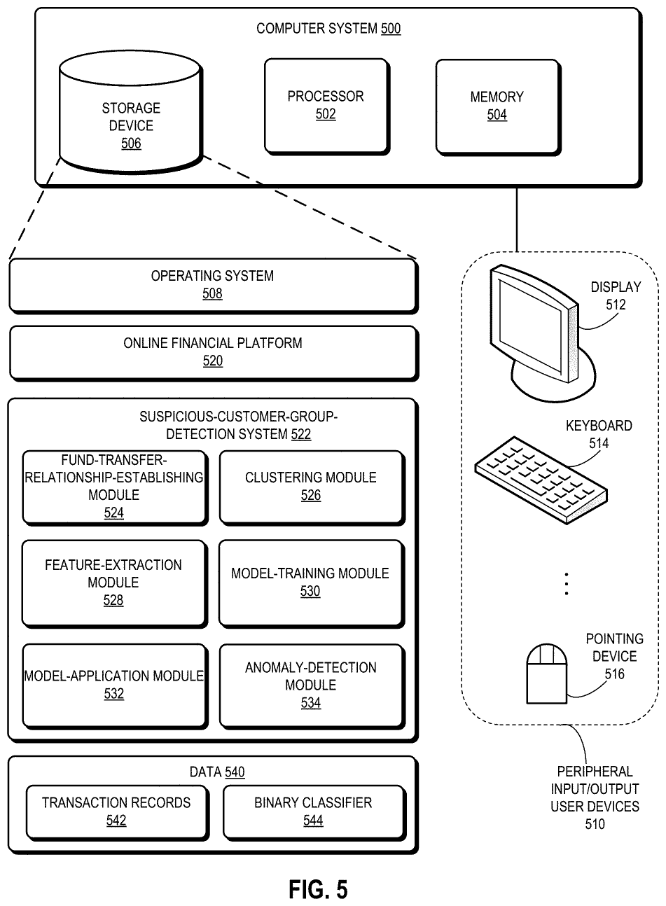

FIG. 5 illustrates an exemplary computer system, according to one embodiment. In FIG. 5, computer system 500 can include a processor 502, a memory 504, and a storage device 506. Furthermore, computer system 500 can be coupled to peripheral input/output (I/O) user devices 510, e.g., a display device 512, a keyboard 514, and a pointing device 516. Storage device 506 can store an operating system 508, an online financial platform 520, a suspicious-customer-group-detection system 522, and data 540.

Online financial platform 520 can include instructions, which can be loaded from storage device 506 into memory 504 and executed by processor 502. As a result, computer system 500 can perform specific functions (e.g., Internet finance services) provided by online financial platform 520.

Suspicious-customer-group-detection system 522 can include instructions, which when executed by computer system 500, can cause computer system 500 or processor 502 to perform methods and/or processes described in this disclosure. Specifically, suspicious-customer-group-detection system 522 can include instructions for establishing fund-transfer relationships among customer accounts (fund-transfer-relationship-establishing module 524), instructions for clustering customer accounts into groups based on the established fund-transfer relationships (clustering module 526), instructions for extracting feature vectors from the clusters (feature-extraction module 528), instructions for training a machine-learning model (model-training module 530), instructions for applying the machine-learning model to identify suspicious customer groups (model-application module 532), and instructions for detecting anomalous customer groups (anomaly-detection module 534).

Data 540 can include transaction records 542 and binary classifier 544. Transaction records 542 can include records of transactions occurring on online financial platform 520. Binary classifier 544 can include the trained machine-learning model.

In some embodiments, online financial platform 520 and the various modules in suspicious-customer-group-detection system 522, such as modules 524, 526, 528, 530, 532, and 534 can be partially or entirely implemented in hardware and can be part of processor 502. Further, in some embodiments, the system may not include a separate processor and memory. Instead, in addition to performing their specific tasks, modules 520, 524, 526, 528, 530, 532, and 534, either separately or in concert, may be part of general- or special-purpose computation engines.

In general, the disclosed embodiments provide a solution to the technical problems of automatic detection of money-laundering activities occurring on online financial platforms by implementing machine-learning techniques (e.g., cluster analysis, classification, anomaly detection, etc.) to mine a vast amount of online transaction records. Compared with traditional approaches that monitor behaviors of individual customers, the disclosed embodiments establish money-transfer relationships among customers in order detect an entire group of customers belonging to a money-laundering gang, which may otherwise be undetectable. The graph-based approach enhances detection speed and efficiency. Moreover, a machine-learning-based anomaly-detection technique allows the system to detect unknown money-laundering risks.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

What is claimed is:

1. A computer-executable method, comprising:
obtaining, by a computer from an online financial platform, online financial transaction records associated with a plurality of customer accounts of the online financial platform;
establishing fund-transfer relationships among the plurality of customer accounts based on the transaction records;
performing, by a computer, a cluster-analysis operation to group the plurality of customer accounts into a number of clusters based on the established fund-transfer relationships; and
applying a machine-learning model to determine whether a respective customer-account cluster is involved in online money laundering.

2. The method of claim 1, further comprising training the machine-learning model using labeled data associated with a set of sample customer-account clusters.

3. The method of claim 2, wherein the machine-learning model comprises a binary-classification model, and wherein training the binary-classification model comprises labeling a first number of sample customer-account clusters as blacklisted and a second number of sample customer-account clusters as whitelisted.

4. The method of claim 3, wherein labeling a respective sample customer-account cluster as blacklisted comprises:
determining that a number of customer accounts within the respective sample customer-account cluster are known money-laundering customer accounts; and
in response to a ratio of the known money-laundering customer accounts within the respective sample customer-account cluster exceeding a predetermined threshold, labeling the respective sample customer-account cluster as blacklisted.

5. The method of claim 1, further comprising:
extracting a feature vector from the respective customer-account cluster; and
using the feature vector as an input to the machine-learning model.

6. The method of claim 1, wherein establishing the fund-transfer relationships among the plurality of customer accounts comprises constructing a fund-transfer graph based on the transaction records, wherein a respective node in the fund-transfer graph corresponds to a customer account, and wherein an edge in the fund-transfer graph corresponds to a fund-transfer relationship between two customer accounts.

7. The method of claim 6, further comprising:
constructing a subgraph for each cluster; and
extracting a feature vector from the subgraph using a technique based on detection of network motifs within the subgraph.

8. The method of claim 1, wherein establishing the fund-transfer relationships comprises determining whether a fund-transfer relationship exists between two customer accounts based on a total amount of funds transferred between the two customer accounts.

9. The method of claim 8, wherein establishing the fund-transfer relationships comprises determining a direction of the fund-transfer relationship between the two customer accounts, and wherein the determined direction includes one of: a first direction, a second opposite direction, and a bi-direction.

10. The method of claim 1, wherein performing the cluster-analysis operation comprises implementing a label propagation algorithm (LPA) or a k-means clustering algorithm.

11. A computer system, comprising:
a processor; and
a storage device coupled to the processor and storing instructions which when executed by the processor cause the processor to perform a method, the method comprising:
obtaining, from an online financial platform, online financial transaction records associated with a plurality of customer accounts of the online financial platform;
establishing fund-transfer relationships among the plurality of customer accounts based on the transaction records;
performing, by a computer, a cluster-analysis operation to group the plurality of customer accounts into a number of clusters based on the established fund-transfer relationships; and
applying a machine-learning model to determine whether a respective customer-account cluster is involved in online money laundering.

12. The computer system of claim 11, wherein the method further comprises training the machine-learning model using labeled data associated with a set of sample customer-account clusters.

13. The computer system of claim 12, wherein the machine-learning model comprises a binary-classification model, and wherein training the binary-classification model comprises labeling a first number of sample customer-account clusters as blacklisted and a second number of sample customer-account clusters as whitelisted.

14. The computer system of claim 13, wherein labeling a respective sample customer-account cluster as blacklisted comprises:
determining that a number of customer accounts within the respective sample customer-account cluster are known money-laundering customer accounts; and
in response to a ratio of the known money-laundering customer accounts within the respective sample customer-account cluster exceeding a predetermined threshold, labeling the respective sample customer-account cluster as blacklisted.

15. The computer system of claim 11, wherein the method further comprises:
extracting a feature vector from the respective customer-account cluster; and
using the feature vector as an input to the machine-learning model.

16. The computer system of claim 11, wherein establishing the fund-transfer relationships among the plurality of customer accounts comprises constructing a fund-transfer graph based on the transaction records, wherein a respective node in the fund-transfer graph corresponds to a customer account, and wherein an edge in the fund-transfer graph corresponds to a fund-transfer relationship between two customer accounts.

17. The computer system of claim 16, wherein the method further comprises:
constructing a subgraph for each cluster; and
extracting a feature vector from the subgraph using a technique based on detection of network motifs within the subgraph.

18. The computer system of claim 11, wherein establishing the fund-transfer relationships comprises determining whether a fund-transfer relationship exists between two customer accounts based on a total amount of funds transferred between the two customer accounts.

19. The computer system of claim 18, wherein establishing the fund-transfer relationships comprises determining a direction of the fund-transfer relationship between the two customer accounts, and wherein the determined direction includes one of: a first direction, a second opposite direction, and a bi-direction.

20. The computer system of claim 11, wherein performing the cluster-analysis operation comprises implementing a label propagation algorithm (LPA) or a k-means clustering algorithm.
